(19) United States
(12) Patent Application Publication
(10) Pub. No.: US 2018/0341671 A1
(43) Pub. Date: Nov. 29, 2018

(54) AUDITING ENTERPRISE RESOURCE PLANNING (ERP) SYSTEMS

(71) Applicant: BABU MATHALIKUNNEL SEBASTIAN, SAN JOSE, CA (US)

(72) Inventor: BABU MATHALIKUNNEL SEBASTIAN, SAN JOSE, CA (US)

(21) Appl. No.: 15/603,444

(22) Filed: May 24, 2017

(51) Int. Cl. G06F 17/30

(52) U.S. Cl. CPC G06F 17/30371; G06F 17/30528; G06F 17/30368; G06F 17/30339

(57) ABSTRACT

Example techniques of auditing an ERP system are described. In an example implementation, a method includes defining a set of criteria to monitor the ERP system, the set of criteria comprises an audit table within the application to provide parameters corresponding to multiple tables within the database of the ERP system, and receiving, application parameters generated by the application corresponding to a table from amongst the multiple tables. The application parameters are indicative of usage statistics of the table captured by the application. Thereafter, table parameters corresponding to the table are received. The table parameters are indicative of usage statistics of the table in the database. The method further includes comparing the application parameters and the table parameters to determine a mismatch and initiating a corrective action in response to the mismatch. The corrective action comprises retrieving data corresponding to the table parameters from a backup in the database.

### TECHNICAL FIELD

The present subject matter generally relates to an application software system and in particular, to auditing ERP systems.

### BACKGROUND

Generally, Enterprise Resource Planning (ERP) systems are utilized for managing internal and external resources of an enterprise, such as financial resources, materials, and human resources. ERP systems include an application layer that is accessible by users or administrators and can operate with different types of databases. The users or the administrators interact with the application and the database to monitor and handle data within multiple tables of the database.

During auditing of ERP systems, a detailed review and validation of the ERP system in terms of functional transactions are performed. Data from the multiple tables of the database and application are recorded and monitored to deduce useful information for the enterprise.

### SUMMARY

The summary is provided to introduce concepts related to auditing an ERP system. The concepts are further described below in detailed description. This summary is no intended not to identify essential features of the claimed subject matter nor it is intended for use in determining or limiting the scope of the claimed subject matter.

In an example implementation of the present subject matter, techniques for auditing the ERP system, having an application integrated with a database includes defining a set of criteria to monitor the ERP system. The set of criteria comprises an audit table within the application to provide parameters corresponding to multiple tables within the database of the ERP system being monitored. Thereafter, receiving application parameters generated by the application corresponding to a table from amongst the multiple tables of the database in the audit table, the application parameters being indicative of usage statistics of the table captured by the application. The technique then includes receiving table parameters corresponding to the at least one table, the table parameters being indicative of usage statistics of the at least one table in the database, wherein the table parameters are received based on a calling operation executed from within the application.

After receiving the application parameters and the table parameters, the technique includes comparing the application parameters and the table parameters to determine a mismatch based on transaction on tables being monitored or a transaction between application recorded transactions and database level transactions. In an aspect, if there is a mismatch or an occurrence of a transaction, notification action is initiated in response to the mismatch or the transaction to commence a corrective action. The corrective action comprises retrieving data corresponding to the table parameters from a backup of data of the multiple tables of the database.

### BRIEF DESCRIPTION OF THE DRAWINGS

The detailed description is described with reference to the accompanying figure(s). In the figure(s), the left-most digit(s) of a reference number identifies the figure in which the reference number first appears. The same numbers are used throughout the figure(s) to reference like features and components. Some implementations of systems and/or methods in accordance with implementations of the present subject matter are now described, by way of example only, and with reference to the accompanying figure(s), in which:

FIG. 1 illustrates components of an Auditing system, in accordance with an example implementation of the present subject matter;

FIG. 2 illustrates a method for auditing an Enterprise Resource Planning (ERP) system, in accordance with an example implementation of the present subject matter;

FIG. 3 illustrates an example method according to an implementation of the present subject matter; and

FIG. 4 illustrates a computing environment implementing a computer readable medium according to an implementation of the present subject matter

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DETAILED DESCRIPTION

Generally, auditing of Enterprise Resource Planning (ERP) systems is performed by monitoring data in multiple audit tables of the database and analyzing the data to extract meaningful information. ERP systems generally do not implement database monitoring integrated within the application, and therefore separate specifications are set up for each table that is to be monitored. Existing techniques of auditing ERP systems utilize modules, such as table triggers which are configured to monitor different sets of tables based on respective specifications.

However, such modules do not provide capability of tracking data in the tables of the database during backend updates or when malicious activities are performed on the data, unless table specific triggers are set up. Further, it is observed that configuring such modules is a process intensive and a time-consuming task and is cost inefficient.

In accordance with an example implementation of the present subject matter, techniques for auditing an ERP system are described. The described techniques of auditing ERP systems are process efficient and cost efficient in processing data and reporting discrepancy in data.

In an implementation of the present subject matter, a method for auditing the ERP system, comprising an application integrated with a database, includes defining a set of criteria to monitor the ERP system. The set of criteria may include defining a table, such as an audit table within the application to provide parameters corresponding to multiple tables within the database of the ERP system being monitored. The method includes receiving application parameters generated by the application. The application parameters can be for instance usage statistics of the tables as recorded by the application. For example, number of times a data is accessed, type of operation, time when the operation is performed, and source of operation.

Thereafter, table parameters corresponding to a table are received from the database. The table parameters are indicative of usage statistics of the table in the database. In one example, the table parameters are received based on a calling operation executed from within the application thereby integrating database monitoring from within the application. The table parameters and the application parameters are then compared to determine if there is a transaction in tables being monitored, or if there is a mismatch between the application parameters corresponding to usage data as recorded by the application and the table parameters, such as recorded data and usage parameters. The transaction may call for database owner's attention or approval and the mismatch may indicate that a data in the database has been updated, owing to an external operation, such as unauthorized access, performed on the data and therefore the data may have a different value.

For instance, the application parameters include that a data of an employee table has been accessed 5 times, whereas the table parameters indicate that the data has been accessed 7 times, then this difference in number of times the data has been accessed indicate that that the data has been updated in the table outside of the application possibly though an unauthorized action.

In an example implementation, a corrective action to fetch more details about the mismatch is initiated. In one example, the corrective action includes retrieving data corresponding to the table parameters from a backup of data of the multiple tables of the database.

Techniques of the present subject matter provide enhanced auditing of the ERP system by providing efficient access control and an approval mechanism to users or database owners of the ERP system and efficient intrusion detection. Therefore, the described techniques provide a process and cost-efficient mechanism of auditing the ERP system.

It should be noted that the description merely illustrates the principles of the present subject matter. It will thus be appreciated that those skilled in the art will be able to devise various arrangements that, although not explicitly described herein, embody the principles of the present subject matter and are included within its spirit and scope. Furthermore, all examples recited herein are principally intended expressly to be only for explanatory purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and implementations of the invention, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the words “connected” and “coupled” are used throughout for clarity of the description and can include either a direct connection or an indirect connection. Thus, if a first device couples to a second device, that connection may be through a direct electrical or mechanical connection, through an indirect electrical or mechanical connection via other devices and connections, through an optical electrical connection, or through a wireless electrical connection. Various implementations of the present subject matter have been described below by referring to several examples.

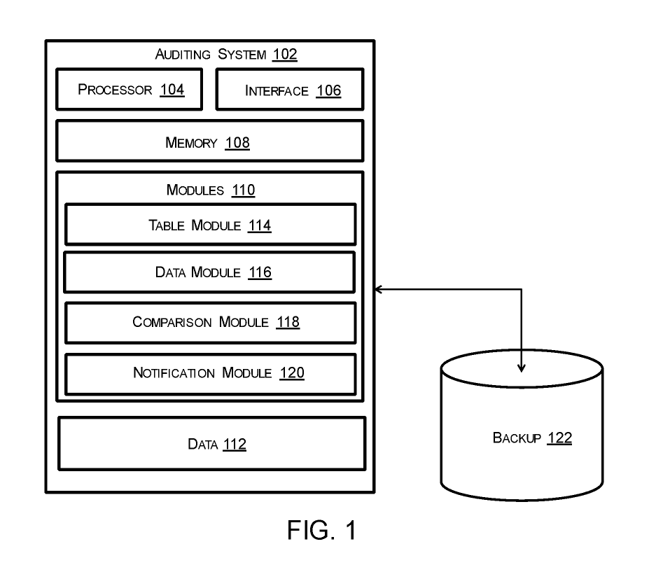

The above-mentioned methods and systems are further described with reference to FIG. 1 to FIG. 4. It should be noted that the description and figures merely illustrate the principles of the present subject matter along with examples described herein and, should not be construed as a limitation to the present subject matter. It is thus understood that various arrangements may be devised that, although not explicitly described or shown herein, embody the principles of the present subject matter. Moreover, all statements herein reciting principles, aspects, and specific examples thereof, are intended to encompass equivalents thereof.

FIG. 1 illustrates components of an auditing system 102, in accordance with an implementation of the present subject matter. The auditing system 102 in an example can be a computing system to implement techniques of the present subject matter as described herein. In an example, the auditing system 102 may be implemented for large applications, such as PeopleSoft ERP, or SAP ERP. The auditing system 102 may include a processor(s) 104, an interface 106, and a memory 108. Further, the auditing system 104 may include modules 110 and data 112.

The processor 104, amongst other capabilities, may be configured to fetch and execute computer-readable instructions stored in the memory 108. The processor 104 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared.

The interface 106 may include a variety of machine readable instructions-based interfaces and hardware interfaces that allow the auditing system 102 to interact with different entities, such as the processor 104, the module 110, and the data 112. Further, the interface 106 may enable the components of the auditing system 102 to communicate with external repositories.

The memory 108 may be coupled to the processor 104 and may, among other capabilities, provide data and instructions for generating different requests. The memory 108 can include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The module(s) 208 may include routines, programs, objects, components, data structures, and the like, which perform particular tasks or implement particular abstract data types. The module 110 may further include modules that supplement applications on the auditing system, for example, modules of an operating system. Further, the module 110 can be implemented in hardware, instructions executed by a processing unit, or by a combination thereof.

In another aspect of the present subject matter, the module 110 may be machine-readable instructions which when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

The data 112 serves, amongst other things, as a repository for storing data that may be fetched, processed, received, or generated by one or more of the module 108.

The module 110 may perform different functionalities which may include, but may not be limited to, defining a set of criteria such as an audit table for providing parameters associated with the table, receiving application parameters related to multiple tables of the database, receiving table parameters, and comparing the application parameters and table parameters to determine a mismatch. Accordingly, the module 110 may include a table module 114 for defining the audit table, a data module 116 for receiving application parameters and table parameters. Further, the module 110 may include a comparison module 118 for comparing the application parameters and the table parameters, and a notification module 120 to generate a notification in response to the mismatch in the application parameters and the table parameters. The data 112 may include details of the tables to be monitored during auditing.

In one example, the auditing system 102 may be coupled to a backup 120 storage to retrieve data corresponding to the table entries. In an example, the backup 120 may exist internally within the auditing system 120 or may be an external database connected to the auditing system 102.

In operation, the table module 114 defines the set of criteria for monitoring and auditing the ERP system. The set of criteria may include identifying tables that require monitoring for data changes. Other tables in the database may not contain valuable data, or may be temporary tables and therefore are not selected for monitoring. Further, the set of criteria may include defining database owners of multiple tables to receive approval and email notifications, and enable the database owners to request additional information, and approve the transactions. The set of criteria also includes, defining a subset of the multiple tables as critical tables that require continuous monitoring and tracking. In one example, the critical tables may be determined based on features provided by the ERP system, such as application delivered audit features implemented by the ERP system. For instance, an employee time reporting table is set up to be audited in the ERP system based on the audit features. In the example, the tables selected for auditing may be reviewed and such tables are provided with default configuration to users, that the tables are critical. Users may change the default configuration provided either to an option of either yes to confirm that the tables are critical, or a no.

In an example implementation of the present subject matter, the set of criteria may include defining predefined number of access operation on tables from amongst the multiple tables having confidential data, and predefined number of rows that are allowed to be accessed in a day. For example, a table storing personal data of a user may include Social Security Number (SSN), credit card details, and date of birth and the predefined number of rows allowed to be accessed in a day may be set to 100 rows a day. If the predefined number of access operation is set that an SSN table may be accessed 5000 times a day, but if table parameters show the SSN table was viewed 6,000 times, then some extra report or download of the SSN table may have happened. Based on this information, a mitigation action can be initiated if the access was illegal. For instance, millions of customer's personal info was downloaded from a website, and yet the issue was detected only when customers complained. Another example can be someone changing bank account of a vendor outside application. For such a table, when a report, a process or a query selects more than 100 rows from this table, an alert or notification may be generated for to designated security or owner groups for immediate attention to check the table and take corrective actions. Such configuration allows designating tables that maintain confidential and critical data, such as employee profile data, and facilitate monitoring employee profile changes and access review.

In another example implementation, the set of criteria may include defining conflicting roles, and non-specialty roles for users and employees of the enterprise, to allow the auditing system disable allocation of conflicting roles to a user, or enforce security review when a role other than non-specialty roles are assigned. In one example, the table module 114 specifies the ‘backup’ database parameters so the process can access and compare data between production system and the backup system. This will also enable system administrators to force the process to run a compare from a different backup than the latest one being made available, in case the latest is compromised.

In another example implementation, the set of criteria includes specifying backup database parameters such that the auditing system 102 can access and compare data between production system and the backup system. This facilitates system administrators to run a comparison from a different backup than a latest backup, in case the latest is compromised.

Thereafter, the table module 114 receives instruction at the application to gather database statistics. For instance, the table module 114 may receive an Oracle execution command “EXEC dbms_stats.flush_database_monitoring_info” to gather the database statistics. Upon receiving the execution command by the database, the table module 114 issues and instruction to gather usage statistics of the tables that are to be monitored by the auditing system 102. In an example, the usage statistics include details such as number of times a data is accessed, type of operation, time when the operation is performed, and source of operation.

The instruction is then provided to the database and the table module updates the tables. The data module 116 then receives the table statistics, referred to as application parameters, hereinafter, from the application. The application parameters are provided in the audit table as internal data. The data module 116 thereafter receives the table parameters by performing a calling operation from within the application. The table parameters may be understood as usage statistics of the tables at the instant when the calling operation is executed. In one aspect of the present subject matter, the tables are set up for monitoring wherein any notification activity may be initiated and processed. It would be noted that the table value is same whether updated through application or from outside. The data is to be updated only through application, so the usage count from the application audit table, and the usage count from the database usage statistics must match.

In an example implementation, after receiving the table parameters and the application parameters the parameters may be processed in two operating modes. In a first operation mode, a comparison module 118 compares the application parameter and the table parameter to determine a mismatch. For instance, the comparison module 118 may compare activity count corresponding to the application parameters and the activity count corresponding to the table parameters and determine if there is a mismatch. In one example, the comparison module 118 determines actual change counts of process run by taking the difference between current process run count and previous process changes count. For instance, if the first process runs returns 10 changes in a table and a second run shows 12 changes. The auditing system 102 may limit the changes to show 2 counts, since the 10 out of 12 was already intimated. In another example, the comparison module 118 may compare the parameters for critical tables. In one aspect, if the parameters do not match means data was updated from outside. For instance, if a timesheet entry table is being monitored and application audit usage count says there are 1000 transactions within a time frame. The table parameters say there are 1001 counts. Therefore 1 transaction was done on DB outside of the application. In an example, a user may have changed the timesheet from outside for an employee having a labor dispute and the management relied on the timesheet at the time of initiating the dispute. However, since the data was changed without management knowledge outside of application, the case becomes invalid.

In case of a mismatch, the comparison module initiates a corrective action. In one example, the corrective action includes accessing the backup 122 to retrieve data or values corresponding to the table parameters. Thereafter, the comparison module 118 generates a report of difference between the data corresponding to the table parameters and the backup data, referred to as delta data hereinafter. The delta data may then be provided to database administrators for monitoring and tracking purpose of the data. In one example, table values are updated in the backup, for example Oracle database by issuing an instruction, such as SELECT * FROM_ALL_TAB_MODIFICATIONS. The result of this statement is stored in the audit table for the auditing system 102 to further monitor and analyze database activities. The Application data will be backed up periodically. When either there is a count difference in table activities in application updates as against database updates or the current ERP system, the comparison module 118 compares the current application data with the latest backed up data and provide delta information to the table owners and security administrators, in order to enable them to review.

In second mode of operation, once the application parameters are received, database owners of the tables may be selected. In one example, based on an application, such as PeopleSoft ERP application, owners of the tables may be derived. For instance, tables that are used to store payroll data are owned by payroll administrators and the payroll administrators are selected in case there are changes in the tables storing the payroll data. The notification module 120 notifies the database owners of the application parameters to receive their approval. For approval, the database owners may analyze the data and may require additional data related to the application parameters.

In an example, a table employee in the database, there may be records such as employee details employee id, bank account number, and department stored in the table. The application parameter of the table may include details such as number of times a bank account number or employee id has been updated or changed. The application parameters may be provided to the database owner of the employee table for approval. If the database owner may require additional data regarding the table, then the database owner may request to retrieve more details from the backup 122.

Thereafter, the notification module 120 may access the backup 122 to fetch details corresponding to the application parameters. The details may include values of the data, change of data, etc. In such a scenario, the notification module 120 may fetch more details, such as value of employee id or bank account number of the employee and provide the details to the database owner. Based on the details, the database owner may determine to approve the application parameters.

In an example implementation of the present subject matter, the comparison module 118 determines if the number of access to tables, for instance restricted tables, exceeds the predefined threshold. The restricted tables may be understood as table from amongst the multiple tables that have the predefined threshold for accessing the tables. Upon determining that the tables have been accessed more than the predefined threshold, database owners of the tables are selected and notified through email communication. The database owners may then verify if the number of accesses to the tables is allowable. In an aspect of the present subject matter, the notification module 120 generates an alert to a security administrator in case the number of accesses is not allowable. The security administrator in response may block access to such tables and perform corrective actions to check if the data being accessed has been misused by an external entity, such as malicious users, malwares or any computer virus.

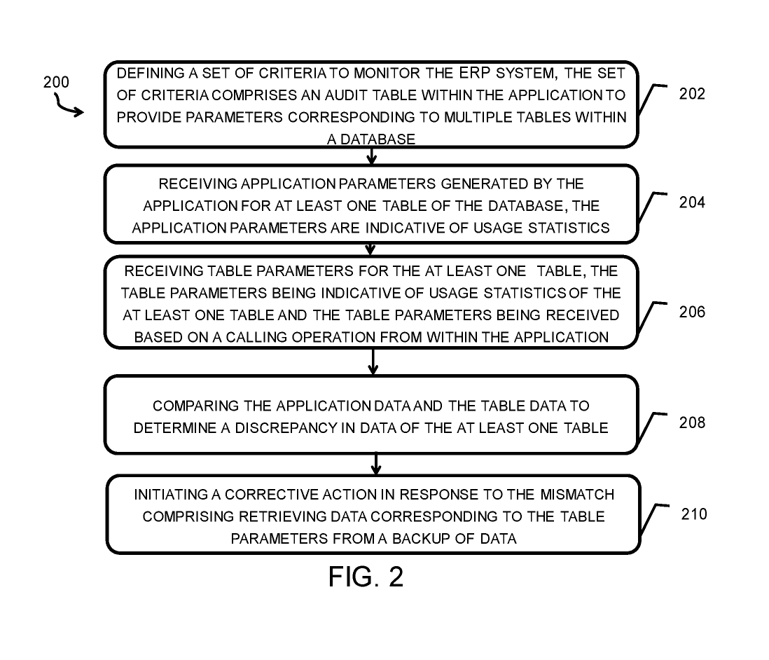

FIG. 2 illustrates method 200 for auditing an ERP system. The order in which the method 200 is described is not intended to be construed as a limitation, and any number of the described method blocks may be combined in any order to implement the method 200 or an alternative method. Furthermore, the method 200 may be implemented by processor(s) or computing system(s) through any suitable hardware, non-transitory machine readable instructions, or combination thereof.

It may be understood that steps of the method 200 may be performed by programmed computing systems. The steps of the method 200 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. In an implementation of the present subject matter, the method 200 may be executed by the auditing system 102, as described earlier.

At block 202, a set of criteria to monitor an ERP system is defined, wherein the set of criteria comprises an audit table within the application to provide parameters corresponding to multiple tables within the database of the ERP system being monitored. In an example implementation, the table module 114 defines the set of criteria for monitoring the ERP system. At block 204, application parameters generated by the application corresponding to at least one table are received from amongst the multiple tables of the database in the audit table, the application parameters being indicative of usage statistics of the at least one table captured by the application.

Thereafter, table parameters corresponding to the at least one table are received at block 206. The table parameters are indicative of usage statistics of the at least one table in the database, wherein the table parameters are received based on a calling operation executed from within the application. At block 208, the application parameters and the table parameters are compared to determine a mismatch. In an example implementation of the present subject matter, the comparison module 118 may compare the application parameters and the table parameters to detect a mismatch. After determining the mismatch, a corrective action is initiated at block 208. In an example, the corrective action comprises retrieving data corresponding to the table parameters from a backup of data of the multiple tables of the database.

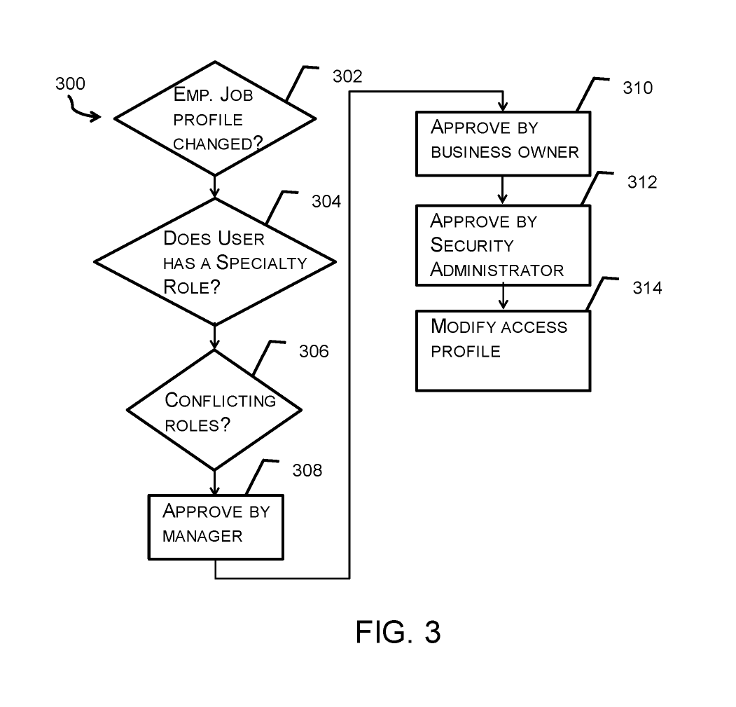

FIG. 3 illustrates an example method 300 in accordance with an implementation of the present subject matter. The example method 300 is described in reference to a change in employee job profile of an employee in a database of an enterprise. In an ERP system, multiple tables including critical tables are continuously monitored for different operations, such as add operation, delete operation, view operation, and change operation. In such a scenario, the table owners are selected and an approval for the performed operations is sent to the table owners.

In an example implementation, at 302, it is determined whether the employee job profile is changed in response to the performed operations. In case the job profile of the employee has changed, then it is determined whether the employee has a specialist role at 304. In next step the specialist role of the employee is compared with the role of the new employee or another employee to determine if there is a conflict, at 306. As an example, if an employee who previously had access to system as an accounts payable clerk, and is now transferred to role voucher entry clerk. In conventional ERP systems implemented in organizations, due to lack of appropriate auditing, the employee may be incorrectly granted additional role of voucher entry clerk without removing previous access as accounts payable clerk. This may violate security policy of the organization. In the said example, the application monitors human resources employee profile table and when the auditing system 102 notes a change in profile due to the employee transfer, the auditing system 102 suspends the previous access if required, and notify security provisioning roles and managers of the need to review new security set up for the employee. Further, the auditing system 102 enables managers to review and approve new access, whereupon the auditing system 102 updates the employee's new access.

In a scenario, when there is a conflict in the roles of the employees, a senior employee, such as a manager is requested for approval at 308. Further, at 310, an approval is taken from business owners regarding the roles of the employee. Thereafter, at 312, approval regarding the job role of the employee is taken from security administrator of the enterprise. The security administrator may further provide approval for other roles defined for the employee. Accordingly, at 314, the access profile of the employees is updated.

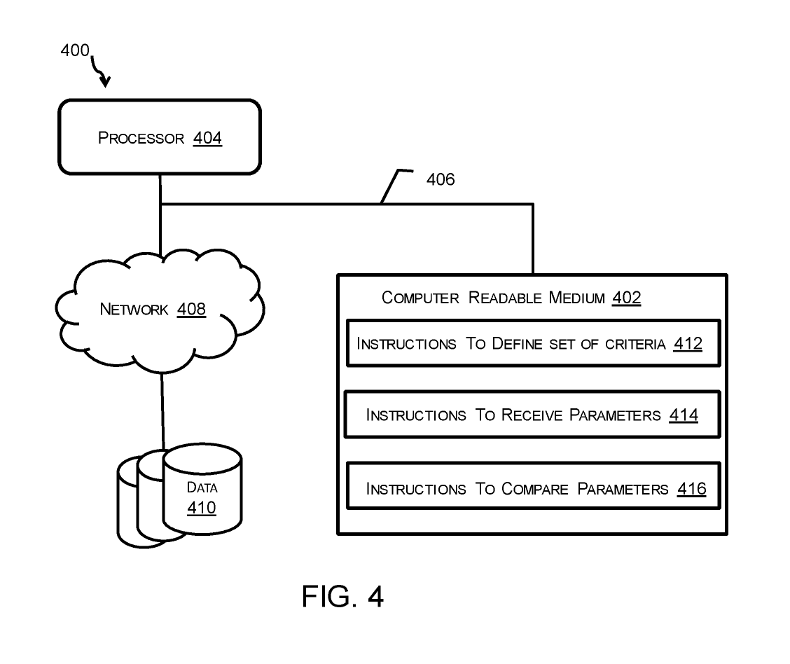

FIG. 4 illustrates a computing environment 400 implementing a non-transitory computer readable medium 402, according to an implementation of the present subject matter. In one implementation, the non-transitory CRM 402 may be utilized by a computing device, such as the auditing system 102. The auditing system 102 may be implemented in a public network environment 400 and may include a processor 404 communicatively coupled to the non-transitory CRM 402 through a communication link 406 connecting to a network 408.

For example, the processor 404 may be implemented in a computing engine such as the auditing system 102 as described earlier. The non-transitory CRM 402 may be for example an internal memory device or an external memory device. In one implementation, the communication link 406 may be a direct communication link, such as any memory read write interface. In another implementation, the communication link 406 may be an indirect communication link, such as a network interface. In such a case, the processor 404 may access the non-transitory CRM 402 through the network 408. The network 408 may be a single network or a combination of multiple networks and may use a variety of different communication protocols.

The processor 404 may be communication with the network environment 400 over the network 408. In one implementation the non-transitory CRM 402 includes a set of computer readable instructions such as instructions to define a set of criteria 412 (instructions 412), instructions to receive parameters 414 (instructions 414), instructions to compare parameters 416 (instructions 416). The set of computer readable instructions may be accessed by the processor 404 through the communication link 406 and subsequently executed to compare the parameters and take corrective actions.

In an example implementation, the processor 404 may access the instructions 412 to define the set of criteria, for instance, database owners, predefined threshold for accessing tables, an audit table. After defining the set of criteria, the processor 404 may access the instructions 414 to receive the application parameters captured by the application corresponding to multiple tables of a database of the ERP system in the audit table. Thereafter, the processor 404 may receive table parameters associated with the tables.

After receiving the application parameters and the table parameters, the processor 404 may access the instructions 416 to compare the application parameters and the table parameters and initiate a corrective action in response to a mismatch between the application parameters and the table parameters. In one example, the corrective action includes retrieving data from a backup of the database. In another example, the corrective action includes providing a notification to the database owner of the at least one table.

Therefore, the described techniques provide enhanced auditing of the ERP system by performing a corrective action based on a mismatch, wherein the corrective action includes referring to a backup of data of the database to retrieve details about the data. Further, the described techniques provide a process and cost-efficient mechanism of auditing the ERP system.

Although implementations of present subject matter have been described in language specific to structural features and/or methods, it is to be understood that the present subject matter is not necessarily limited to the specific features or methods described. Rather, the specific features and methods are disclosed and explained in the context of a few example implementations for projection systems.

I/We claim:

1. A method for auditing an Enterprise Resource Planning (ERP) system, the ERP system having an application integrated with a database, the method comprising:
defining, by a processor of an audit system, a set of criteria to monitor the ERP system, wherein the set of criteria comprises an audit table within the application to provide parameters corresponding to multiple tables within the database of the ERP system being monitored;
receiving, by the processor, application parameters generated by the application corresponding to at least one table from amongst the multiple tables of the database in the audit table, wherein the application parameters are indicative of usage statistics of the at least one table captured by the application;
receiving, by the processor, table parameters corresponding to the at least one table, the table parameters being indicative of usage statistics of the at least one table in the database, wherein the table parameters are received based on a calling operation executed from within the application;
comparing, by the processor, the application parameters and the table parameters to determine a mismatch; and
initiating a corrective action in response to the mismatch, wherein the corrective action comprises retrieving data corresponding to the table parameters from a backup of data of the multiple tables of the database.

2. The method as claimed in claim 1 further comprising generating delta data corresponding to difference in data corresponding to the table parameters and the data in the backup.

3. The method as claimed in claim 1 further comprises:
identifying database owners associated with the at least one table;
generating notification for the database owners, wherein the notification comprises number and type of operations performed on data of the at least one table;
receiving from the database owners input to provide details of the table parameters; and
retrieving data corresponding to the table parameters from the backup.

4. The method as claimed in claim 1, wherein the comparing further comprises:
determining, by the processor, number of access operations to a table from amongst the multiple tables exceeding a predefined number of access operations to be allowed within the table;
selecting database owner of the table;
generating notification for the database owner; and
providing an alert to a security administrator based on the determination.

5. The method as claimed in claim 4, wherein the access operations are indicative of at least one of mod, insert, view, delete, and select operations.

6. An audit system for auditing an Enterprise Resource Planning (ERP) system, the ERP system comprising an application integrated with a database, the audit system comprising:
a processor;
a table module, coupled to the processor, to define an audit table to provide parameters corresponding to multiple tables within the database of the ERP system being monitored;
a data module, coupled to the processor, to:
receive application parameters generated by the application corresponding to at least one table from amongst the multiple tables of the database, wherein the application parameters are indicative of usage statistics of the at least one table captured by the application; and
receive table parameters corresponding to updates in the at least one table, the table parameters being indicative of usage statistics of the at least one table in the database;
a comparison module to
determine a mismatch between the application parameters and the table parameters; and
initiate a corrective action in response to the mismatch, wherein the corrective action comprises retrieving data corresponding to the table parameters from a backup of data of the multiple tables of the database.

7. The audit system as claimed in claim 6 further comprising a notification module to
identify database owner of the at least one table;
generate notification for the database owner, wherein the notification comprises number and type of operations performed on data of the at least one table.

8. The audit system as claimed in claim 6, wherein the comparison module is to further:
determine number of access operations to a table from amongst the multiple tables exceeding a predefined number of access operations to be allowed within the table; and
select database owner of the table for notification.

9. The audit system as claimed in claim 7, wherein the access operations are indicative of at least one of mod, insert, view, delete, and select operations.

10. A non-transitory computer readable medium for auditing an Enterprise Resource Planning (ERP) system, the ERP system having an application integrated with a database, the computer readable medium comprising instructions executable by a processor to:
define a set of criteria to monitor the ERP system, wherein the set of criteria comprises an audit table within the application, wherein the audit table is to provide parameters corresponding to multiple tables within the database being monitored;
receive application parameters generated by the application corresponding to at least one table from amongst the multiple tables of the database, wherein the application parameters are indicative of usage statistics of the at least one table captured by the application;
receive table parameters corresponding to the at least one table, wherein the table parameters are indicative of usage statistics of the at least one table, wherein the table parameters are received by performing a calling operation from within the application;
compare the application parameters and the table parameters to determine a mismatch; and
initiate a corrective action in response to the mismatch, wherein the corrective action comprises retrieving data corresponding to the table parameters from a backup of data of the multiple tables of the database.

11. The non-transitory computer readable medium as claimed in claim 10, wherein the instructions to define further comprises defining database owner of the at least one table.

12. The non-transitory computer readable medium as claimed in claim 11, wherein the corrective action includes providing a notification to the database owner of the at least one table.
